(19) United States
(12) Patent Application Publication
(10) Pub. No.: US 2008/0189614 A1
(43) Pub. Date: Aug. 7, 2008

(54) TERMINAL AND MENU DISPLAY METHOD

(75) Inventors: Kye Sook Jeong, Seoul (KR); Ha Yang Jung, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 12/027,134

(22) Filed: Feb. 6, 2008

(30) Foreign Application Priority Data
Feb. 7, 2007 (KR) 10-2007-0012631

(51) Int. Cl. G06F 3/048

(52) U.S. Cl. 715/716; 715/767

(57) ABSTRACT

A terminal, computer program product and method for displaying menu icons in groups and for designating one of the menu icons displayed in groups when a menu icon mode is entered.

### CROSS REFERENCE TO RELATED APPLICATIONS

This nonprovisional application claims priority under 35 U.S.C. §119(a) on Patent Application No. 10-2007-0012631 filed in Republic of Korea on Feb. 7, 2007 the entire contents of which are hereby incorporated by reference.

### BACKGROUND

1. Field of the Invention

This document relates to a menu display method for displaying menus.

2. Related Art

In recent years, various portable device functions have converged into common terminals. Accordingly, the number of menus in these terminals has increased in number, size and complexity. In these terminals, conventional menus are hierarchically arranged by dividing the menus into top and bottom menus. However, conventional menus force users to execute an excessive number of selection operations in order to select the desired menus of these terminals.

### SUMMARY

An aspect of this document is to provide a menu display method which may effectively display menus of multiple functions, along with a corresponding terminal and computer program product.

In one aspect of the invention, a menu display method includes the ability to select a menu mode. This method may display the menus by groups and designate one of the displayed menus when the menu mode is entered. Also, this method may change the designation of a menu belonging to a group different from that of the designated menu when a tab is selected.

In another aspect of the invention, a terminal includes an input and a display for displaying menus. This terminal may include a controller. The controller causes the display to display the menus by groups and designates one of menus when the menu mode is selected by using the input. The controller may change the designation of a menu belonging to a group different from that of the designated menu when a tab is selected via the input. Another aspect of the invention is a corresponding computer program product.

### BRIEF DESCRIPTION OF THE DRAWINGS

The implementation of this document will be described in detail with reference to the following drawings in which like numerals refer to like elements.

FIG. 1 is a block diagram illustrating a terminal according to one embodiment;

FIG. 2 is a flow chart of a menu icon display method of a terminal according to another embodiment;

FIGS. 3A to 3D are examples of the screens that display menu icons through a display of FIG. 1;

FIGS. 4A to 4D are another examples of the screens that display menu icons through the display of FIG. 1;

FIGS. 5A to 5D are still another examples of the screens that display menu icons through the display of FIG. 1;

FIG. 6 is an example of the screen that displays the result of a menu icon selection in the state of FIG. 3A through the display of FIG. 1;

FIGS. 7A to 7C are examples of the screens that display the result of sorting the menu icons through the display of FIG. 1; and

FIG. 8 is an example of the screen that displays a menu icon search result through the display of FIG. 1;

### DETAILED DESCRIPTION

An implementation of this document will be described in detail with reference to the attached drawings.

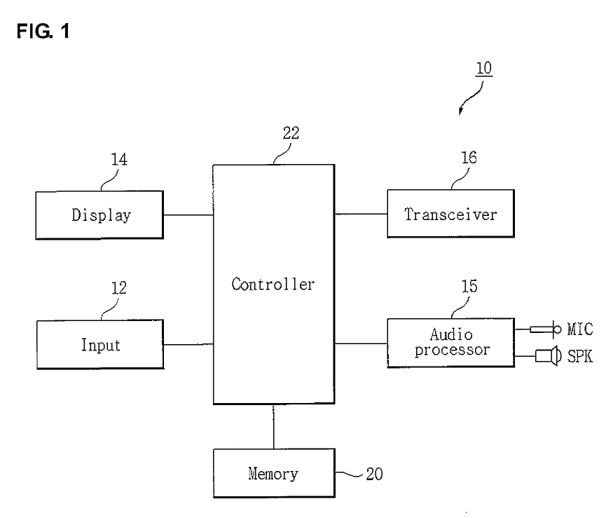

FIG. 1 is a block diagram illustrating a terminal according to one embodiment.

Referring to FIG. 1, the terminal 10 according to one embodiment comprises an input 12, a display 14, an audio processor 15, a transceiver 16, a memory 20, and a controller 22.

The input 12 is an interface which communicates with a peripheral device or a user. The input 12 may be at least one of a keypad having a plurality of key buttons formed thereon, a navigation key having a plurality of direction keys formed thereon, a jog device for selecting an input according to the amount of rotation, a voice input device having a voice recognizer, and a touch input device, such as a touch pad or touch screen. Various information or commands, for example, information or commands related to menu access or menu designation, menu selection, tab selection, menu sorting, menu search and the like, are input into the terminal 10 from a peripheral device or a user through the input 12.

The display 14 controllably displays a variety of processes and control operations of the terminal 10, a variety of images, etc., according to instructions from the controller 22. The display 14 provides inputs of various information or commands related to menu access or menu designation, menu selection, tab selection, menu sorting, menu search and the like exemplified above through the screen. By the inputs of various information or commands displayed through the display 14, the user may know the progress of a variety of processes and control operations of the terminal 10.

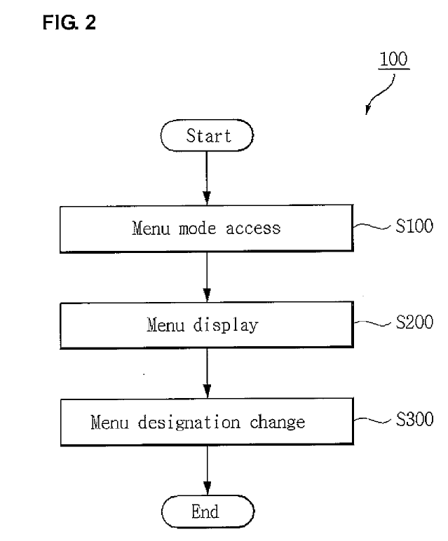

If one of a specific number of menu icons is designated by using the input 12 at the menu mode, the display 14 displays the menu icons into groups. If the tab is selected at the above state by using the input 12, the display 14 displays the designation of a menu icon belonging to a group different from that of the designated menu icon. The display 14 also displays the result of menu icon sorting and searching provided by the terminal 10. A description thereof will be described in detail with reference to FIGS. 2 to 7 hereinafter.

In the terminal 10 according to one embodiment, the display 14 is integrated with a touch input 12 such as a touch screen, to thus display various information or commands 12 related to menu icon access, menu icon designation, menu icon selection, tab selection, menu icon sorting, menu icon search, etc. and at the same time a variety of commands may be input when the displayed information or commands is touched.

The audio processor 15 processes data so as to input and output voice through a microphone MIC and a speaker SPK. The audio processor 15 processes data so as to output voice through a speaker SPK corresponding to a variety of processes and control operations of the terminal 10. The audio processor 15 processes data so as to let voice according to various information or commands to be input through a microphone MIC.

The audio processor 15 may generate sound through the speaker SPK when a menu icon is designated or selected. Especially, in case the menu icons sorted and displayed on the display 14 by groups are selected by using the input 12, different sounds may be generated by groups.

Additionally, the audio processor 15 may receive sound through the microphone MIC by the input 12 for inputting various information or commands, for example, information or commands related to menu icon access or menu icon designation, menu icon selection, tab selection, menu icon sorting, menu icon search and so on, if a voice input device having a voice recognizer stored therein is provided, and then transmit it to the voice recognizer.

The transceiver 16 may perform voice or data communication through wired and wireless communication networks. A so-called communication terminal comprising the transceiver 16 may perform a variety of current or future communications, such as voice call, message transfer, webpage connection, data transmission and reception, call connection, instant messenger, etc.

The memory 20 may store programs for processing and controlling the terminal 10, especially, the controller 22. The memory 20 may store a variety of data, for example, reference data, various storage data, and various updatable data for storage. The memory 20 stores the frequency of use of the menu icons that were explained above or to be explained later, a final menu icon display state, the proximity between the menu icons, recently used menu icons and so on, so that the memory 20 may be used to display on the display 14 information or commands related to menu icon access or menu icon designation, menu icon selection, tab selection, menu icon sorting, menu icon search and so on.

The controller 22 processes and controls overall operations or functions of the terminal 10. Particularly, the controller 22 processes and controls the overall operations or functions of the terminal 10 related to menu icon access or menu icon designation, menu icon selection, tab selection, menu icon sorting, menu icon search, etc., on the display 14.

FIG. 2 is a flow chart of a menu icon display method of a terminal according to another embodiment.

Referring to FIG. 2, the menu icon display method S100 according to another embodiment includes a menu icon mode access step S100, a menu icon display step S200, and a menu icon designation change step S300.

The menu icon mode access step S100 is a step for accessing the menu icon mode to perform a predetermined function by menu icon display and selection. In step S100, methods for accessing the menu icon mode may be various.

For example, either a menu key or a menu hot key may be provided on the surface of the terminal 10. Accordingly, the menu mode may be accessed by pressing either the menu key or the hot key. In another example, the menu button may be displayed on the display 14 such as the touch screen, and the menu mode may be accessed by touching the displayed menu button.

The menu icon mode access step S100 may be performed on an initial screen of the terminal 10, and also may be performed during the execution of a variety of menu icons, for instance, during the execution of a game or camera shooting.

The menu icon display step S200 is a step for displaying a specific number of menu icons through the display 14 in the menu icon mode accessed in the step S100.

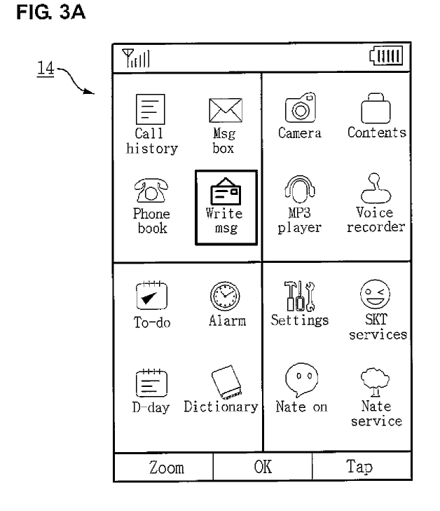

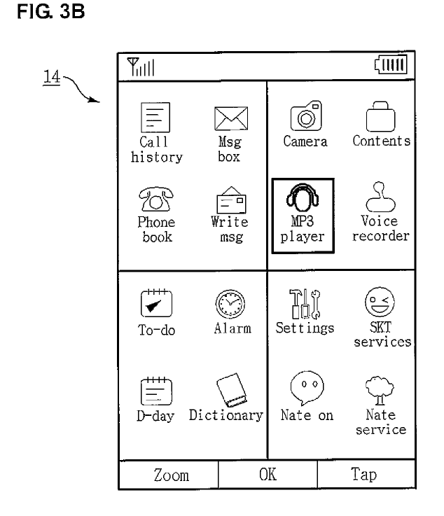

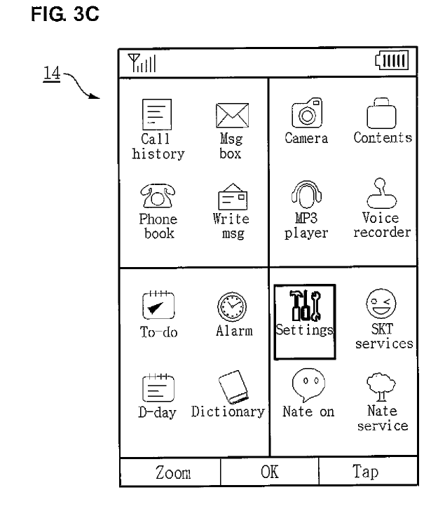

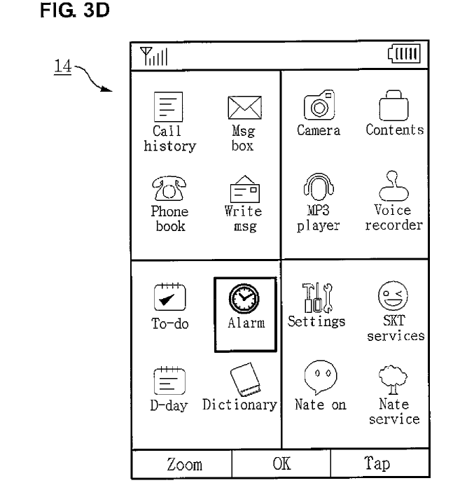

FIGS. 3A to 3D are examples of the screens that display menu icons through the display of FIG. 1.

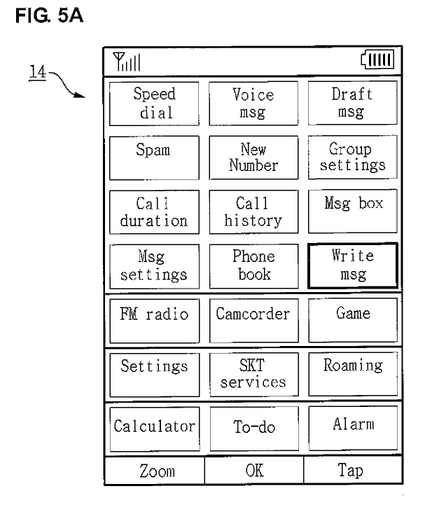

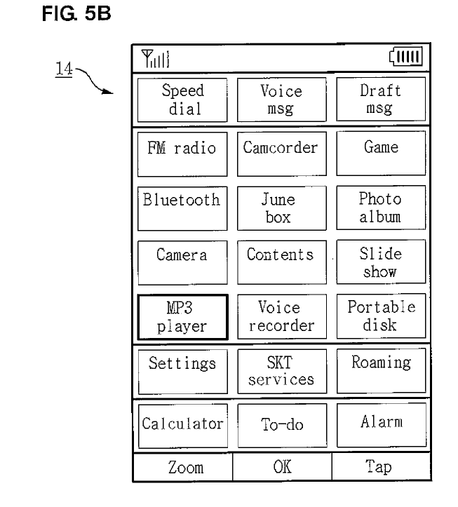

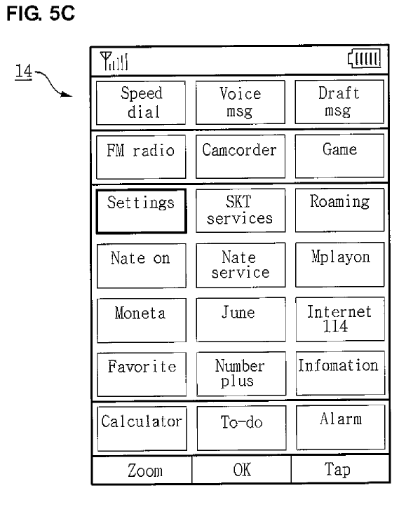

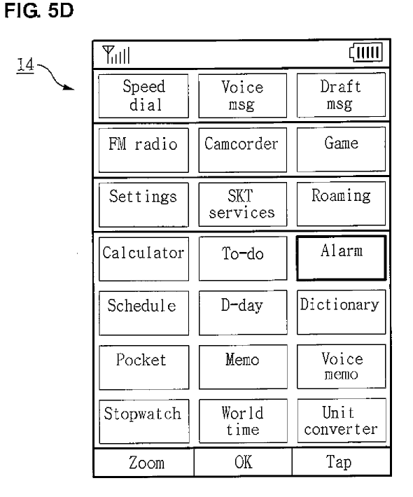

FIGS. 3A to 3D are screens where a total of 16 menu icons are sorted and displayed into fours by groups on each of equally divided quadrants on the display 14. FIG. 3A is a screen where one of the menu icons to be displayed on the fourth quadrant is designated among the menu icons to be displayed on equally divided quadrants. And FIGS. 5B to 3D are screens which are the same as FIG. 3A, except for changing the designation of one of the menu icons displayed on of the first to third quadrants respectively.

In the step S200, the first screen displaying a specific number of menu icons may be any one of FIGS. 3A to 3D. In the step S200, a user may arbitrarily set the first screen as one of FIGS. 3A to 3D, or may set the first screen as the menu icon screen displayed when the menu icon mode is accessed for the last time. The latter will be described by way of example. If the last menu icon screen is the screen of FIG. 3B, the first screen in the step S200 may be the screen of FIG. 3B at the time of menu icon mode access. The latter is more effective when the last menu icons used by users are frequently used when the menu icon mode is accessed at the next time.

Further, frequently used menu icons among the menu icons displayed on the menu icon screen of FIGS. 3A to 3D may be positioned near the boundary line of the quadrants. Accordingly, a menu having a higher frequency of use is positioned closer to the center point of the quadrants or arranged in a cruciform near the boundary points of the quadrants. The former may be effective when the input 12 is a touch input device, and the latter may be effective when the input 12 is a normal navigation key.

The frequently used menu icons are positioned at the boundary line of the quadrants, and the initially designated menu icons of FIGS. 3A to 3D may be one of the four menu icons positioned at the center lines of the quadrants.

The menu icons displayed on the menu icon screens of FIGS. 3A to 3D may be displayed by icons, or by the icons along with at least one of characters, numbers and special characters for explaining the menu icons.

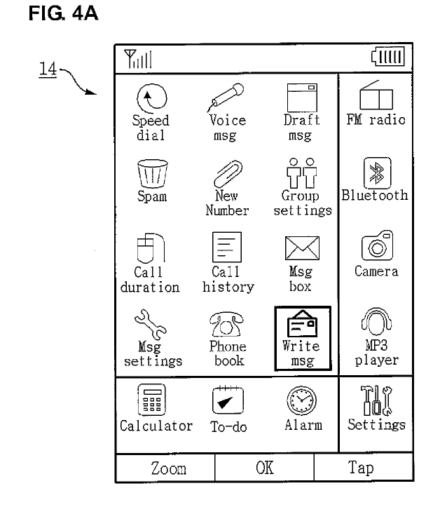

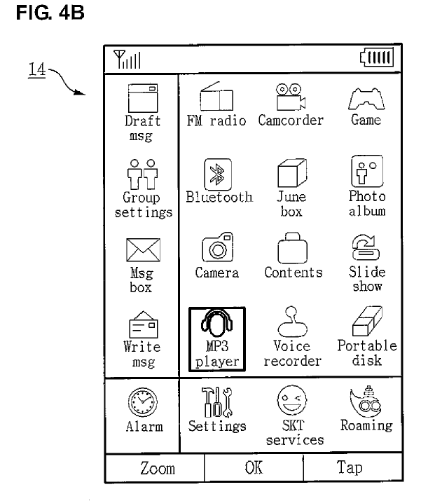

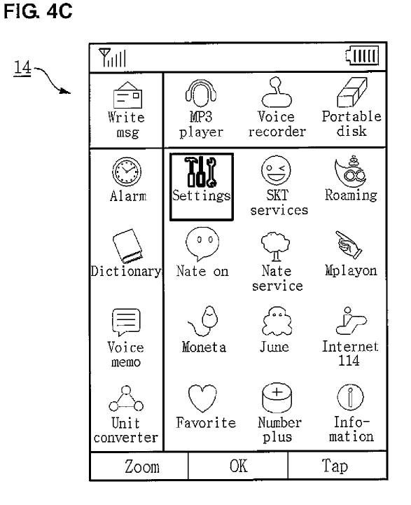

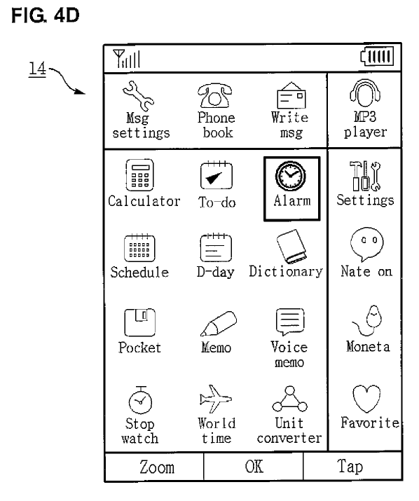

FIGS. 4A to 4D are another examples of the screens that display menu icons through the display of FIG. 1.

FIGS. 4A to 4D are screens where a total of 20 menu icons are sorted and displayed by groups on each of unequally divided quadrants, proceeding clockwise with the first quadrant being the upper right quadrant. FIG. 4A is a screen where 12 menu icons are positioned on the fourth quadrant of the unequally divided quadrants, 4 menu icons are positioned on the first quadrant, 3 menu icons are positioned on the third quadrant and one menu icon is positioned on the second quadrant. Further, FIG. 4A shows the state in which the frequently used menu icons positioned on the center point of the quadrants are designated among the menu icons positioned on the fourth quadrant in the same way as FIG. 3A.

FIGS. 4B to 4D are screens where the menu icons are aligned and displayed in the same way as FIG. 4A, with the first to third quadrant having 12 menu icons, respectively, with three menu icons or one menu icon positioned on the other quadrants. FIG. 4B to FIG. 4D show the state in which the frequently used menu icons positioned on the center point of the quadrants are designated among the menu icons positioned on the fourth quadrant in the same way as FIG. 4A. Between FIGS. 4A-4D, there are 48 menu icon icons grouped into 4 sets of 12. Depending on which mode is selected, a set of 12 menu icons occupies the largest quadrant, a set of 4 occupies another quadrant, a set of 3 occupies another quadrant, and a set of 1 occupies the last quadrant. In each of the four menu icons, the most frequently used menu icon icons are displayed next to the respective quadrant boundary.

Referring to FIG. 2 again, in the step S200, the first screen for displaying a specific number of menu icons will be one of FIGS. 4A to 4D. As explained above, in the step S200, a user may arbitrarily set the first screen as one of FIGS. 4A to 4D, or may set the first screen as the menu icon screen displayed for the last time.

In the step S200, the user may set if the first screen is set as one of FIGS. 3A to 3D or as one of FIGS. 4A to 4D, and change the setting.

The designation change step S300 is a step in which the designation is changed to one of the menu icons belonging to a group different from that of the designated menu icon when the tab is selected.

For example, in a case where FIG. 4A is the first screen in the menu icon display step S200, the first screen is changed into the screen illustrated in FIG. 4B through a display 14 when a tab is selected by using an input 12 menu icon. Further, when the tab is selected again through the input 12, the screen is switched over to the screen illustrated in FIG. 4C, and when the tab is selected once again, the screen is switched over to the screen illustrated in FIG. 4D.

As the menu icons are sorted by groups for display, and a group is changed by tab selection, the menu icons belonging to the group are displayed more than the menu icons belonging to other groups, thereby minimizing the number of times of menu icon designation and selection. By sequential tab selection, all the menu icons (a total of 48 menu icons in FIGS. 4A to 4D) distributed among each of the groups as shown in FIGS. 4A to 4D are sequentially displayed, and a desired menu icon may be designated, or selected and designated by using a navigation key or a touch screen.

The tab may be selected by displaying a tab key on the lower end of the screen to be displayed and pressing the tab key. Or the tab may be selected by having a hot key for the tab formed on a part of the body, for example, a side of the case, of the terminal 10a and pressing the hot key for the tab.

Resultantly, as many menu icons belonging to each of the groups as possible are displayed by tab selection. The phase “as many menu icons as possible” may mean all the menu icons of the terminal 10 or only the menu icons expected to be used to more than a certain extent. The latter means that a maximum zoomed out screen is configured only by the menu icons expected to be used to a certain extent except for the exceptional menu icons which makes a critical error if the menu icons are only exceptionally used or the operation is wrong.

In the step S200 or S300, as for the menu icons displayed through the display 14, as shown in FIGS. 3A to 4D, (1) the menu icons are displayed by icons and/or character sets, (2) the menu icons are sorted by groups and displayed on quadrants, and (3) the frequently used menu icons may be aligned so as to be concentrically spread from the boundary line or the central point of the quadrant, but the present invention is not limited thereto.

FIGS. 5A to 5D are still another examples of the screens that display menu icons through the display of FIG. 1.

As shown in FIGS. 5A to 5D, the menu icons displayed through the display 14 in the step S200 or S300 are displayed as one of characters, numbers, special characters or a combination thereof and may be sorted up and down by groups for displaying. In this case, the frequently used menu icons may be positioned on the upper end or lower end of a group, or displayed so that they are discriminated from other menu icons of the corresponding group. In the latter, only the frequently used menu icons are shadow-processed, marked with a distinctive color, highlighted, or enlarged. Thus, in FIGS. 5A-5D, the selected group displays 12 menu icons, while the three unselected groups each display a single row of 3 most frequently used menu icons.

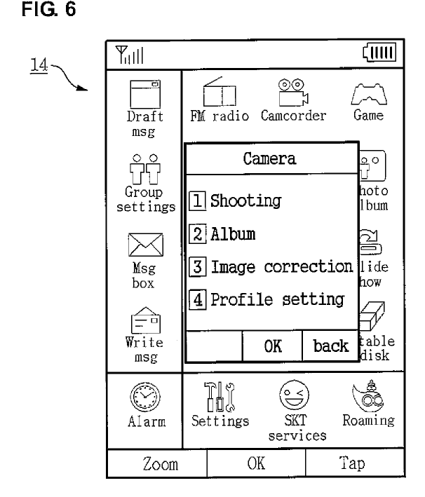

FIG. 6 is an example of the screen that displays the result of a menu icon selection in the state of FIG. 3A through the display of FIG. 1.

As shown in FIGS. 3A to 4D, the menu icons displayed through the display 14 in the step S200 or S300 may be selected through the input 12. For example, as shown in FIG. 3A, a desired menu icon is accessed by using navigation keys, and then the menu icon may be selected by pressing a confirm button or an OK button on the screen. At this time, if a selected menu icon is an execution menu icon, the corresponding menu icon is executed.

On the other hand, if subordinate menu icons exist on the selected menu icon, as shown in FIG. 6, the subordinate menu icons are additionally displayed by pop-up. Of course, the subordinate menu s may be selected by selecting the subordinate menu icons displayed by pop-up by using the input 12 in a similar method to the methods explained above. The pop-up screen of FIG. 6 moves back to the menu icon screen of FIG. 3A by selecting the back menu icon.

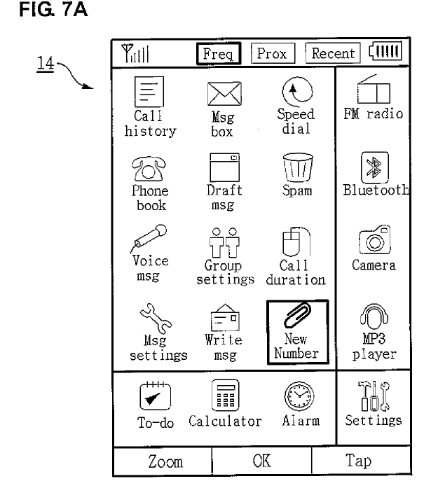

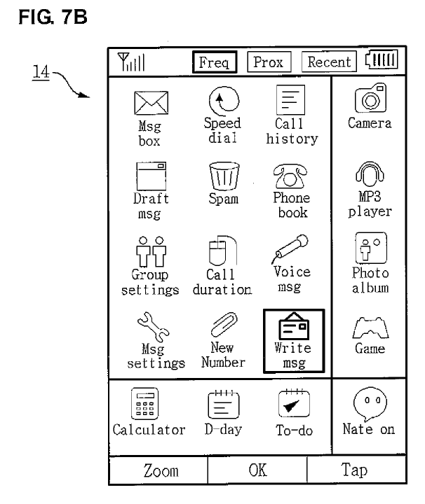

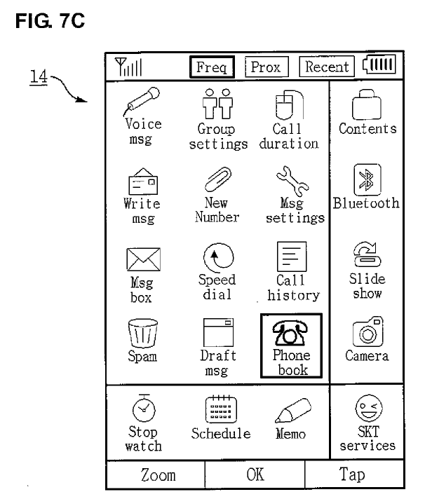

FIGS. 7A to 7C are examples of the screens that display the result of sorting the menu icons through the display of FIG. 1.

The menu icon display method of a terminal according to one embodiment may further comprise the step of displaying a sorting menu icon.

The sorting menu icons as shown in FIGS. 7A to 7C may be further displayed at parts of the menu icon screens as shown in FIGS. 3A to 4D or so as to be identified. At this time, the sorting methods may vary, including frequently used sorting, proximity sorting, and recent sorting.

Referring to FIG. 7A, if the frequently used sorting method is selected among the sorting methods, the menu icons that have been used most frequently may be aligned at a specific position, for example, at the boundary line of the quadrants on the menu icon screen of FIGS. 3A to 4D. Especially, the most frequently used menu icons are positioned at four center points of the quadrants, and the frequently used menu icons of the corresponding groups may be aligned on the boundary line of a cruciform according to the frequency of use.

Referring to FIG. 7B, when the proximity sorting method is selected from the sorting methods, the menu icons belonging to each of the groups of the quadrant may be set such that the menu icons are aligned according to the degree of proximity. According to this method, the menu icons in proximity to each other can be sequentially used. Also, after the menu icons in proximity to each other are firstly aligned in order to select desired menu icons, the next step may be performed.

Referring to FIG. 7C, it is possible to align the most recently used menu icons around the center points of the quadrants by selecting the recent sorting method among the sorting methods. Such a sorting method may be useful when the recently used menu icons are used again.

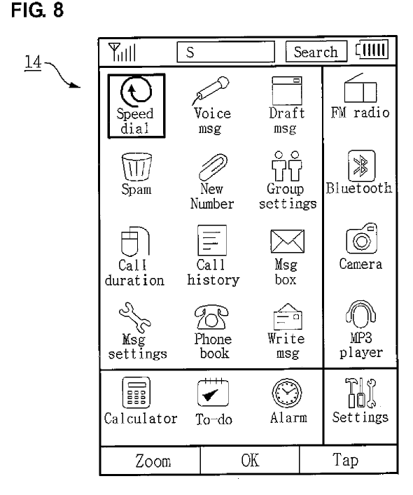

FIG. 8 is an example of the screen that displays the result of a menu icon search through the display of FIG. 1.

Referring to FIG. 8, the menu icon display method of a terminal according to one embodiment may include the step of displaying a search window for searching menu icons and entering a search word into the search window or displaying a search result in case of a search request.

The search result may be displayed such that the searched menu icons are distinguished from the other menu icons. The searched menu icons are distinguished from the other menu icons by either shade, highlight, enlarge or a combination thereof. In another example, the search result may be aligned at the boundary lines of the quadrant that divides the groups of the menu icons as shown in FIGS. 3A to 4D. Since the searched menu icons are aligned at the boundary lines of the quadrant, the searched menu icons may be easily accessed by using only navigation keys which are one of the input 12.

Although embodiments have been described above, the present invention is not limited thereto.

Although the above embodiment has been described that the menu icons are divided into quadrants and sorted by groups for display, the menu icons may be divided into three, six, etc. Further, in the present invention, the menu icons may be displayed without division by groups.

Although the above embodiment has been described that the menu icons are displayed in an icon form, they may be displayed by either general characters, numbers or special characters or a combination thereof with or without the icon.

Although the above embodiment has been described that the menu icons are visually displayed, the menu icons may be provided so that they may be recognized with other senses. For example, the menu icons may be provided in braille that the blind may recognize tactually. In this case, the number of the menu icons provided in braille may be larger or smaller by zoom in our zoom out.

Although the above embodiment has been described that the total number of the menu icons to be displayed on the display is 4×4=16 and nine menu icons, three menu icons, three menu icons and one men are displayed respectively at the time of differential division, the total number of the menu icons to be displayed on the display may be other than 16. For example, the total number of the menu icons to be displayed on the display may be 6×6=36, and sixteen menu icons, eight menu icons, eight menu icons and four menu icons may be displayed respectively on each of the quadrants.

Additionally, the total number of the menu icons to be displayed on the display or the number of the menu icons to be displayed on each of the quadrants may be changed.

Although the above embodiment has been described with respect to methods for aligning menu icons to be sorted by groups, the methods for aligning menu icons are not limited thereto. For example, the menu icons may be arbitrarily aligned by drag (slide) and drop by the user. In another example, the menu icons may be aligned in various methods, such as in name order, size order, creation date order, format order, etc.

The present invention may be practiced in software stored on a computer readable medium such as a disk or computer memory device. A description of how a computer works is found in “How Computers Work,” Ron White, Que Publishing, 8^{th} Edition, November 2005, the entire contents of which being incorporated herein by reference.

Although the embodiment of the present invention has been described with reference to the accompanying drawings, it will be appreciated that the above described invention may be embodied in other specific forms without departing from the spirit or essential characteristics thereof. The present embodiments are, therefore, to be considered in all aspects as illustrative and not restrictive, the scope of the invention being indicated by the appended claims rather than by the foregoing description, and all changes which come within the meaning and range of equivalency are, therefore, intended to be embraced therein.

What is claimed is:

1. A computer based menu icon display method, comprising:
displaying menu icons on a terminal in groups and a designated menu icon selected from the menu icons of one of the groups; and
selecting a menu icon belonging to a different group to become the designated menu icon.

2. The method of claim 1, wherein the step of displaying comprises:
displaying the menu icons with at least one of character, symbol and number.

3. The method of claim 1, wherein the step of displaying comprises:
displaying the menu icons in quadrants, with each group assigned to a respective quadrant.

4. The method of claim 3, wherein the step of displaying the menu icons in quadrants comprises:
displaying frequently used menu icons of each group closest to boundary lines of the quadrants.

5. The method of claim 1, further comprising:
executing an operation if a selected menu icon is an execution menu icon; and
if a subordinate menu icon exists relative to the selected menu icon, displaying the subordinate menu icon.

6. The method of claim 3, wherein the step of displaying the menu icons in quadrants comprises:
displaying the menu icons in quadrants of unequal size, wherein a quadrant containing the designated menu icon is the largest quadrant.

7. The method of claim 6, wherein the step of displaying the menu icons in quadrants of unequal size comprises:
changing quadrant sizes so that a size of a quadrant encompassing the selected menu icon becomes the largest quadrant.

8. The method of claim 7, wherein the step of selecting a menu icon belonging to a different group comprises:
selecting a most frequently used menu icon belonging to the different group.

9. The method of claim 1, further comprising:
displaying a menu icon sorting toolbar containing at least two of a frequent use menu selection icon, a proximity menu selection icon, and a recently used menu selection icon.

10. The method of claim 1, further comprising:
searching menu icons based upon a search term entered into a search window; and
displaying a search result.

11. The method of claim 10, the step of displaying a search result further comprising:
displaying menu icons corresponding to the search result with either shade, highlight, enlargement or a combination thereof.

12. The method of claim 1, wherein the step of displaying menu icons in groups comprises:
displaying menu icons in groups corresponding to groups displayed when the menu icon mode was last selected.

13. The method of claim 3, further comprising:
playing a first audio sound for a menu of a first quadrant and a second audio sound for a menu of a second quadrant.

14. A terminal, comprising:
an input;
a display; and
a controller configured to control the display to display menu icons in groups and a designated menu icon from the menu icons of one of the groups,
wherein when a menu icon belonging to a different group is selected as the designated menu icon through the input, the controller configured to control the menu icon belonging to a different group to become the designated menu icon.

15. The terminal of claim 14, wherein the controller is configured to divide the menu icons into groups for display onto respective group areas, with frequently used menu icons of each group positioned adjacent to inner boundary lines of the areas.

16. The terminal of claim 14, wherein the controller is configured to configured to divide the menu icons into groups for display onto respective group areas, with an area containing the designated menu icon being the largest area.

17. The terminal of claim 16, wherein the controller is configured to cause a size of an area corresponding to the different group to become the largest area when the menu icon belonging to the different group becomes the designated menu icon.

18. The terminal of claim 14, further comprising:
an audio device configured to play a first audio sound for a menu of a first quadrant and a second audio sound for a menu of a second quadrant.

19. The terminal of claim 14, wherein the controller is configured to cause the display to display menu icons in groups corresponding to groups displayed when the menu mode was last selected.

20. The terminal of claim 14, wherein the controller is configured to cause the display to display a search screen, the controller further configured to search the menu icons.

21. The terminal of claim 14, wherein the controller is configured to cause the display to display a menu icon sorting toolbar containing at least two of a frequent use menu selection icon, a proximity menu selection icon, and a recently used menu selection icon.
